(19) United States
(12) Patent Application Publication
(10) Pub. No.: US 2025/0039976 A1
(43) Pub. Date: Jan. 30, 2025

(54) METHOD AND DEVICE FOR WIRELESS COMMUNICATION

(71) Applicants: Yu CHEN, Shanghai (CN); Xiaobo ZHANG, Shanghai (CN)

(72) Inventors: Yu CHEN, Shanghai (CN); Xiaobo ZHANG, Shanghai (CN)

(73) Assignee: SHANGHAI LANGBO COMMUNICATION TECHNOLOGY COMPANY LIMITED, Shanghai, OT (CN)

(21) Appl. No.: 18/783,381

(22) Filed: Jul. 24, 2024

(30) Foreign Application Priority Data
Jul. 28, 2023 (CN) 202310945384.3

(51) Int. Cl. H04W 76/27

(52) U.S. Cl. CPC H04W 76/27

(57) ABSTRACT

Receiving a first signaling, and the first signaling indicating releasing an RRC connection; as a response to receiving the first signaling, entering RRC_IDLE state or RRC_INACTIVE state, accompanying the behavior of entering RRC_IDLE state or RRC_INACTIVE state, executing cell selection; the behavior of executing cell selection comprising evaluating a first cell within a target time length; the target time length depending on whether a first SSB group is on demand; the first SSB group belonging to the first cell; herein, the meaning of the phrase that the target time length depends on whether an SSB of the first cell is on demand comprises: when an SSB of the first cell is on demand, the target time length is a first value; when an SSB of the first cell is not on demand. The present application enables better cell selection in complex environments through the first signaling.

### CROSS REFERENCE TO RELATED APPLICATIONS

This application claims the priority benefit of Chinese Patent Application No. 202310945384.3, filed on Jul. 28, 2023, the full disclosure of which is incorporated herein by reference.

### BACKGROUND

### Technical Field

The present application relates to transmission methods and devices in wireless communication systems, involving measurement, cell selection, and energy saving.

### Related Art

Application scenarios of future wireless communication systems are becoming increasingly diversified, and different application scenarios have different performance demands on systems. In order to meet different performance requirements of various application scenarios, 3rd Generation Partner Project (3GPP) Radio Access Network (RAN) #72th plenary decided to conduct a study of New Radio (NR), or what is called fifth Generation (5G). A work Item (WI) of NR was approved at 3GPP RAN #75th plenary to start standardization work on NR.

In communications, whether Long Term Evolution (LTE) or 5G NR involves features of accurate reception of reliable information, optimized energy efficiency ratio, determination of information efficiency, flexible resource allocation, scalable system structure, efficient non-access layer information processing, low service interruption and dropping rate and support for low power consumption, which are of great significance to the maintenance of normal communications between a base station and a UE, reasonable scheduling of resources and balancing of system payload. Those features can be called the cornerstone of high throughout and are characterized in meeting communication requirements of various service, improving spectrum utilization and improving service quality, which are indispensable in enhanced Mobile BroadBand (eMBB), Ultra Reliable Low Latency Communications (URLLC) and enhanced Machine Type Communications (eMTC). Meanwhile, in the following communication modes, covering Industrial Internet of Things (IIoT), Vehicular to X (V2X), Device to Device communications, Unlicensed Spectrum communications, User communication quality monitoring, network planning optimization, Non-Territorial Networks (NTN), Territorial Networks (TN), and Dual connectivity system, there are extensive requirements in radio resource management and selection of multi-antenna codebooks as well as in signaling design, adjacent cell management, service management and beamforming. Transmission methods of information are divided into broadcast transmission and unicast transmission, both of which are essential for 5G system for that they are very helpful to meet the above requirements. The UE can be connected to the network directly or through a relay.

With the increase of scenarios and complexity of systems, higher requirements are raised for interruption rate and time delay reduction, reliability and system stability enhancement, service flexibility and power saving. At the same time, compatibility between different versions of different systems should be considered when designing the systems.

3GPP standardization organization has done relevant standardization work for 5G and formed a series of standards. The standard contents can be referred to:
https://www.3gpp.org/ftp/Specs/archive/38_series/38.101-1/38101-1-h00.zip
https://www.3gpp.org/ftp/Specs/archive/38_series/38.304/38304-h00.zip
https://www.3gpp.org/ftp/Specs/archive/38_series/38.321/38321-h00.zip
https://www.3gpp.org/ftp/Specs/archive/38_series/38.331/38331-h00.zip

### SUMMARY

In a wireless communication system, when a terminal enters RRC_IDLE state or RRC_INACTIVE state, cell selection is required, and the cell selection involves cell evaluation, e.g., evaluating a first cell, and the terminal assesses the first cell within a target time length, and the evaluation of the first cell is related to whether the first SSB group is on demand, so how to determine the target time length is a problem to be solved. Researchers also found that determining a reasonable target time length is necessary when the target time length is too short which may result in the first node not being able to complete the evaluation of the cell, and when the target time length is too long which may result in evaluating the cell taking longer time and may result in a delay in cell selection. Researchers further found that whether a first SSB group of the first cell is on demand affects time of the cell evaluation, and therefore it is desirable to determine time of the evaluation of the first cell based on whether the first SSB group of the first cell is on demand, so that the cell evaluation can be completed in the proper time. Researchers further found that the first SSB group for the first cell is on demand, which facilitates the saving of electricity in the first cell and is good for green environment, but creates a new challenge for the evaluation against the first cell, which needs to be rationalized in light of this new situation to determine the time of evaluation of the cell. It is also desirable to be more flexible in determining the target time length when the first SSB group of the first cell may dynamically or semi-statically perform transmission using an on-demand approach.

To address the above problem, the present application provides a solution.

It should be noted that if no conflict is incurred, embodiments in any node in the present application and the characteristics of the embodiments are also applicable to any other node, and vice versa. And the embodiments in the present application and the characteristics in the embodiments can be arbitrarily combined if there is no conflict. Meanwhile, the method proposed in the present application can also be used to solve other communication problems, such as related problems encountered in evolving mobile communication systems.

In one embodiment, interpretations of the terminology in the present application refer to definitions given in the 3GPP TS38 series.

In one embodiment, interpretations of the terminology in the present application refer to definitions given in the 3GPP TS37 series.

The present application provides a method in a first node for wireless communications, comprising:
receiving a first signaling, the first signaling indicating releasing an RRC connection; as a response to receiving the first signaling, entering RRC_IDLE state or RRC_INACTIVE state; accompanying the behavior of entering RRC_IDLE state or RRC_INACTIVE state, executing cell selection; the behavior of executing cell selection comprising evaluating a first cell within a target time length; the target time length depending on whether a first SSB group is on demand; the first SSB group belonging to the first cell;
herein, the meaning of the phrase that the target time length depends on whether an SSB of the first cell is on demand comprises: when an SSB of the first cell is on demand, the target time length is a first value; when an SSB of the first cell is not on demand, the target time length is a second value.

In one embodiment, a problem to be solved in the present application comprises: how to determine a target time length for nodes entering RRC_IDLE or INACTIVE state, and/or how to determine a target time length based on whether the first SSB group is on demand, i.e. evaluating a time of a first cell.

In one embodiment, advantages of the above method comprise: saving electricity, especially the electricity of network; supporting an SSB of a cell to be transmitted in an on-demand method, which is more flexible; reducing the time required for cell selection, improving the reliability of cell selection, and avoiding or shortening the time when terminals are unreachable.

Specifically, according to one aspect of the present application, the first cell is a candidate cell for cell selection.

Specifically, according to one aspect of the present application, the meaning of evaluating a first cell is or comprises: measuring at least one SSB in the first SSB group to obtain a first measurement result; the first measurement result measures quality of the first cell.

Specifically, according to one aspect of the present application, the meaning of evaluating a first cell is or comprises: assessing quality of the first cell.

Specifically, according to one aspect of the present application, the meaning of evaluating a first cell is or comprises: evaluating whether the first cell is a suitable cell.

Specifically, according to one aspect of the present application, the meaning of evaluating a first cell is or comprises: determining Srxlev of the first cell, and whether the Srxlev of the first cell comprises a first offset depending on whether the first SSB group is on demand; when the first SSB group is on demand, the Srxlev of the first cell comprises a first offset; when the first SSB group is not on demand, the Srxlev of the first cell does not comprise a first offset.

Specifically, according to one aspect of the present application, the behavior of executing cell selection comprises: when no suitable cell is found within a time length of the first value, performing a cell evaluation within a time length of the second value; when a suitable cell is found within a time length of the first value, selecting the suitable cell.

Specifically, according to one aspect of the present application, the second value depends on a period of resources requesting SSBs comprised in the first SSB group.

Specifically, according to one aspect of the present application, monitor a paging on at least one time-frequency resource; the at least one time-frequency resource depends on whether the first SSB group is on demand.

Specifically, according to one aspect of the present application, as a response to a first condition being satisfied, transmit a first signal, the first signal requests an SSB of the first cell; receive an SSB of the first cell; herein, the first condition comprises failure to receive an SSB of the first cell within a time length of a first value.

Specifically, according to one aspect of the present application, as a response to a second condition being satisfied, transmit a first signal, the first signal requests an SSB of the first cell; receive an SSB of the first cell; herein, the second condition comprises failure to found a suitable cell within a time length of a third value.

Specifically, according to one aspect of the present application, as a response to the first cell not meeting S criterion within a first time length, initiate measurements on all neighboring cells; the first time length depends on whether the first SSB group is on demand; herein, the first node selects the first cell.

Specifically, according to one aspect of the present application, the first node is an IoT terminal.

Specifically, according to one aspect of the present application, the first node is a UE.

Specifically, according to one aspect of the present application, the first node is a relay.

Specifically, according to one aspect of the present application, the first node is an access network device.

Specifically, according to one aspect of the present application, the first node is a vehicle terminal.

Specifically, according to one aspect of the present application, the first node is an aircraft.

Specifically, according to one aspect of the present application, the first node is a mobile phone.

The present application provides a first node for wireless communications, comprising:
a first receiver, receiving a first signaling, the first signaling indicating releasing an RRC connection; as a response to receiving the first signaling, entering RRC_IDLE state or RRC_INACTIVE state; accompanying the behavior of entering RRC_IDLE state or RRC_INACTIVE state, executing cell selection; the behavior of executing cell selection comprising evaluating a first cell within a target time length; the target time length depending on whether a first SSB group is on demand; the first SSB group belonging to the first cell;
herein, the meaning of the phrase that the target time length depends on whether an SSB of the first cell is on demand comprises: when an SSB of the first cell is on demand, the target time length is a first value; when an SSB of the first cell is not on demand, the target time length is a second value.

In one embodiment, the present application has the following advantages over conventional schemes:
helping users in RRC_IDLE state or RRC_INACTIVE state to conduct cell evaluation within a reasonable time, which can complete the evaluation of a suitable cell or stop the unrestricted assessment of suitable cells in a timely manner;
with low complexity and development costs;
being more flexible;
being conducive to saving electricity on the network;
ensuring the continuity of communications and coverage, and shortening access latency;
on-demand SSBs are not supported by legacy users, and if on-demand SSBs can be supported, it is beneficial to obtain services from these cells that use on-demand SSBs, therefore, it is very advantageous for transmission and reception of services and timely response to paging.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a schematic diagram of receiving a first signaling, entering RRC_IDLE state or entering RRC_INACTIVE state, and executing cell selection according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of radio signal transmission according to one embodiment of the present application;

FIG. 6 illustrates a schematic diagram of cell evaluation according to one embodiment of the present application;

FIG. 7 illustrates a schematic diagram of a first period according to one embodiment of the present application;

FIG. 8 illustrates a schematic diagram of a first timer according to one embodiment of the present application;

FIG. 9 illustrates a schematic diagram of a processor in a first node according to one embodiment of the present application;

FIG. 10 illustrates a schematic diagram of a processor in a first node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

Embodiment 1 illustrates a schematic diagram of receiving a first signaling, entering RRC_IDLE state or entering RRC_INACTIVE state, and executing cell selection according to one embodiment of the present application, as shown in FIG. 1. In FIG. 1, each step represents a step, it should be particularly noted that the sequence order of each box herein does not imply a chronological order of steps marked respectively by these boxes.

In Embodiment 1, the first node in the present application receives a first signaling in step 101; enters RRC_IDLE state or RRC_INACTIVE state in step 102; executes cell selection in step 103.

Herein, the first signaling indicates releasing an RRC connection; the first signaling triggers the first node to enter RRC_IDLE state or RRC_INACTIVE state; the behavior of executing cell selection comprises evaluating a first cell within a target time length; the target time length depends on whether a first SSB group is on demand; the first SSB group belongs to the first cell; the meaning of the phrase that the target time length depends on whether an SSB of the first cell is on demand comprises: when an SSB of the first cell is on demand, the target time length is a first value; when an SSB of the first cell is not on demand, the target time length is a second value.

In one embodiment, the first node is a User Equipment (UE).

In one embodiment, interpretations of the terminology in the present application refer to definitions given in the 3GPP TS38 series.

In one embodiment, the first node is in RRC_CONNECTED state when receiving the first signaling.

In one embodiment, the method proposed in the present application is unrelated to sidelink communications.

In one embodiment, the method proposed in the present application is applied with a direct communication between the terminal and the network.

In one embodiment, a serving cell refers to a cell where a UE camps; executing a cell search comprises: the UE searches for a suitable cell of a selected Public Land Mobile Network (PLMN) or a Stand-alone Non-Public Network (SNPN), selects the suitable cell to provide available services, and monitors a control channel of the suitable cell, and this procedure is defined as camping on a cell; that is, a camped cell is a serving cell of the UE relative to the UE. Advantages of camping on a cell in RRC_IDLE state or RRC_INACTIVE state are: enabling the UE to receive system information from the PLMN or the SNPN; after registration, if the UE wishes to establish an RRC connection or continue a suspended RRC connection, the UE can achieve this by executing an initial access on a control channel of a camped cell; the network may page the UE; so that the UE can receive notifications of Earthquake and Tsunami Warning System (ETWS) and Commercial Mobile Alert System (CMAS).

In one embodiment, for a UE in RRC_CONNECTED state that is not configured with carrier aggregation/dual connectivity (CA/DC), only one serving cell comprises a PCell. For a UE in RRC_CONNECTED state that is configured with CA/DC, a serving cell is used to indicate a cell set comprising a Special Cell (SpCell) and all sub-cells. The PCell is a cell in a Master Cell Group (MCG), which works at primary frequency, and the UE executes an initial connection establishment procedure or initiates a connection re-establishment on the PCell. For a dual connectivity operation, a Secondary Cell Group (SCG) refers to a PCell of an MCG or a Primary SCG Cell (PSCell) of an SCG; if it is not a dual connectivity operation, an SpCell refers to a PCell.

In one embodiment, a frequency at which a Secondary Cell (SCell) works is a sub-frequency.

In one embodiment, an individual content of an information element is called a field.

In one embodiment, a Multi-Radio Dual Connectivity (MR-DC) refers to a dual connectivity between an E-UTRA and an NR node, or a dual connectivity between two NR nodes.

In one embodiment, in MR-DC, a radio access node providing a control-plane connection to the core network is a master node, and the master node may be a master eNB, a master ng-eNB, or a master gNB.

In one embodiment, an MCG refers to, in MR-DC, a group of serving cells associated with a master node, comprising a SpCell, and optionally one or multiple SCells.

In one embodiment, a PCell is an SpCell of an MCG.

In one embodiment, a PSCell is an SpCell of an SCG.

In one embodiment, in MR-DC, a control plane connection to the core network is not provided, and a radio access node providing extra resources to the UE is a sub-node. The sub-node can be an en-gNB, a sub-ng-eNB or a sub-gNB.

In one embodiment, in MR-DC, a group of serving cells associated with a sub-node is a Secondary Cell Group (SCG), comprising an SpCell and, optionally, one or multiple SCells.

In one embodiment, after the first node enters RRC_IDLE state or RRC_INACTIVE state, there is no SCG or MCG.

In one embodiment, both MCG and SCG are configured in RRC_CONNECTED state.

In one embodiment, after the first node enters RRC_IDLE state or RRC_INACTIVE state, through cell selection, if a suitable cell is found, it camps on this cell.

In one embodiment, an RRC information block refers to an information element in an RRC message.

In one embodiment, SSB can be referred to as SS/PBCH, or SS block.

In one embodiment, a Synchronization Signal and PBCH block (SSB) comprises a primary synchronization signal and a secondary synchronization signal, and the primary synchronization signal and the secondary synchronization signal as well as the PBCH occupy fixed time-frequency resources.

In one embodiment, a PBCH bears a master information block (MIB), and the MIB indicates key information required to access the system, comprising system frame number.

In one subembodiment of the embodiment, an MIB carries information required to receive SIB1.

In one subembodiment of the embodiment, an MIB determines a common control resource set.

In one subembodiment of the embodiment, an MIB indicates a common subcarrier spacing.

In one subembodiment of the embodiment, an MIB indicates whether a cell is barred.

In one embodiment, an SS/PBCH block is used for measurement.

In one embodiment, in existing technology, the acquisition of SIB1 and MIB is not dependent on demand.

In one embodiment, it should be understood by those skilled in the art that what constitutes RRC_CONNECTED state, RRC_IDLE state, and RRC_INACTIVE state is prior art.

In one embodiment, the first signaling is an RRC signaling.

In one embodiment, the first signaling is a higher-layer signaling.

In one embodiment, the first signaling comprises an NAS signaling.

In one embodiment, the first signaling comprises an RRCRelease message.

In one embodiment, the first signaling comprises an RRCConnectionRelease message.

In one embodiment, the first signaling comprises an RRCReleaseNR message.

In one embodiment, before receiving the first signaling, the first node is in RRC_CONNECTED state.

In one embodiment, before receiving the first signaling, the first node is not in RRC_CONNECTED state.

In one subembodiment of the above embodiment, the first signaling is part of a random access procedure.

In one subembodiment of the above embodiment, the first signaling is used to respond to an RRC establishment request transmitted by the first node.

In one subembodiment of the above embodiment, the first signaling is used to respond to an RRC recovery request transmitted by the first node.

In one embodiment, releasing an RRC connection comprises: leaving RRC_CONNECTED state.

In one embodiment, releasing an RRC connection comprises: releasing radio resources.

In one embodiment, releasing an RRC connection comprises: resetting a MAC.

In one embodiment, releasing an RRC connection comprises: releasing radio bearer.

In one embodiment, releasing an RRC connection comprises: stopping at least one timer.

In one embodiment, releasing an RRC connection comprises: releasing a key.

In one embodiment, releasing an RRC connection comprises: releasing a measurement object.

In one embodiment, releasing an RRC connection comprises: releasing dedicated random access resources.

In one embodiment, releasing an RRC connection comprises: releasing RLC bearer and/or RLC entity.

In one embodiment, releasing an RRC connection comprises: releasing a radio bearer other than SRB0 (signaling radio bearer 0).

In one embodiment, the first signaling indicates at least a first cell.

In one embodiment, only when the first SSB group is on demand, the first signaling indicates at least first cell.

In one embodiment, when the first SSB group is not on demand, the first cell is any candidate cell of cell selection.

In one embodiment, when the first SSB group is not on demand, the first cell is any cell found during cell search.

In one embodiment, when the first SSB group is not on demand, system information broadcasted by a cell where the first node camps indicates the first cell.

In one embodiment, the first signaling indicating at least a first cell comprises: the first signaling only indicates a first cell.

In one embodiment, the first signaling indicating at least a first cell comprises: the first signaling indicating a cell list, and the cell list comprising the first cell.

In one subembodiment of the embodiment, the cell list comprises multiple cells.

In one embodiment, the first cell is a transmitter of the first signaling.

In one embodiment, the first cell is a PCell of the first node upon receiving the first signaling.

In one embodiment, the first cell is an adjacent cell of the first node.

In one embodiment, the first signaling indicates the first cell by indicating a global identity of the first cell.

In one embodiment, the first signaling indicates the first cell by indicating a physical cell identity of the first cell.

In one embodiment, the first signaling indicates the first cell by indicating a physical cell identity and/or frequency of the first cell.

In one embodiment, the first signaling comprises an identity of the first cell.

In one embodiment, upon receiving the first signaling, the first node releases an RRC connection.

In one embodiment, the first signaling triggers the first node to leave RRC_CONNECTED state.

In one embodiment, the first signaling triggers the first node to enter RRC_IDLE state.

In one embodiment, the first signaling triggers the first node to enter RRC_INACTIVE state.

In one embodiment, the first signaling triggers the first node to enter RRC_IDLE state.

In one embodiment, the first signaling indicates the first node enters RRC_IDLE state or RRC_INACTIVE state.

In one embodiment, when the first signaling does not indicate that the first node enters the RRC_INACTIVE state, then the first node enters RRC_IDLE state.

In one embodiment, when the first signaling comprises a first field, the first node enters RRC_INACTIVE state.

In one embodiment, when the first signaling does not comprise a first field, the first node enters RRC_IDLE state.

In one embodiment, the first field is suspendConfig.

In one embodiment, an execution of the first signaling comprises entering RRC_IDLE state or entering RRC_INACTIVE state.

In one embodiment, an execution of the first signaling comprises executing cell selection.

In one embodiment, upon receiving the first signaling, the first node must enter RRC_IDLE state or RRC_INACTIVE state.

In one embodiment, upon receiving the first signaling, the first node must perform cell selection.

In one embodiment, entering RRC_IDLE state, the first node must perform cell selection.

In one embodiment, entering RRC_INACTIVE state, the first node must perform cell selection.

In one embodiment, through cell selection, the first node searches for a suitable cell for a selected Public Land Mobile Network (PLMN).

In one embodiment, the network, such as the core network, will configure which PLMN the first node selects.

In one embodiment, an SIM (subscriber identity module) card of the first node pre-configures which PLMN the first node selects.

In one embodiment, the cell selection comprises: performing the required measurements.

In one embodiment, the cell selection comprises: detecting and synchronizing with a broadcast channel; receiving and processing broadcast information; submitting non-access layer system information to the non-access layer.

In one embodiment, the cell selection comprises: searching a suitable cell.

In one embodiment, the cell selection comprises: if a cell is found to meet the criteria for cell selection, then camping on this cell.

In one embodiment, a measurement procedure comprised in the cell selection comprises evaluating the first cell within the target time length.

In one embodiment, the first node needs to complete an evaluation for the first cell within the target time length.

In one embodiment, the target time length is for the first cell.

In one embodiment, whether the first cell belongs to a measurement procedure or a measurement requirement is assessed within the target time length.

In one embodiment, evaluating the first cell comprises assessing quality of the first cell.

In one embodiment, evaluating the first cell comprises evaluating whether the first cell is a suitable cell.

In one embodiment, evaluating the first cell comprises performing measurements on the first cell and judging whether a measurement result meet the criteria for cell selection.

In one embodiment, evaluating the first cell comprises performing measurements on the first cell and judging whether a measurement result is greater than a certain threshold.

In one subembodiment of the embodiment, the certain threshold is network configured.

In one subembodiment of the embodiment, a measurement result of the first cell is greater than the certain threshold, the first cell can be selected.

In one embodiment, the first SSB group comprises at least one SSB.

In one embodiment, the first SSB group is associated with at least one SSB-index.

In one embodiment, each SSB in the first SSB group is associated with an SSB-index.

In one embodiment, an SSB-index is used to identify an SSB.

In one embodiment, an SSB-index is an index of an SSB.

In one embodiment, the first signaling indicates the first SSB group.

In one embodiment, the first signaling indicates the first SSB group by indicating each SSB in the first SSB group.

In one embodiment, the first signaling indicates the first SSB group by indicating an index of each SSB in the first SSB group.

In one embodiment, the first SSB group consists of all SSBs in the first cell.

In one embodiment, the first SSB group only comprises an SSB.

In one embodiment, the first SSB group consists of K SSBs with best quality from the first cell.

In one subembodiment of the above embodiment, K is a positive integer.

In one subembodiment of the above embodiment, K is equal to 1.

In one subembodiment of the above embodiment, K SSBs with best quality are K SSBs with best measurement results.

In one embodiment, the first SSB group consists of SSBs of the first cell involved in evaluating quality of the first cell.

In one embodiment, the first SSB group consists of all CD-SSBs (cell defining SSBs) in the first cell.

In one embodiment, a CD-SSB is an SSB associated with SIB1.

In one embodiment, the first node can obtain SIB1 from CD-SSB or obtain search space of a PDCCH that needs to be monitored to receive SIB1.

In one embodiment, an NCD-SSB is an SSB that does not indicate SIB1.

In one embodiment, the first node is unable to obtain SIB1 through an NCD-SSB.

In one embodiment, the first node is unable to obtain search space of a physical downlink control channel (PDCCH) that needs to be monitored for receiving SIB1 through an NCD-SSB.

In one embodiment, when the first cell comprises on-demand SSBs, the first SSB group consists of all on-demand SSBs of the first cell.

In one embodiment, the first SSB group consists of all on-demand SSBs of the first cell.

In one embodiment, the first SSB group consists of all SSBs of the first cell indicated by the first signaling.

In one embodiment, the first SSB group consists of all SSBs for measurements of the first cell indicated by the first signaling.

In one embodiment, the first SSB group is on demand, and each SSB in the first SSB group is on demand.

In one embodiment, the first SSB group is on demand, and the first SSB group is not actively transmitted.

In one embodiment, the first SSB group is on demand, and the first node needs to transmit a demand signal before the first cell transmits an SSB.

In one embodiment, the first SSB group is on demand, and the first node needs to transmit a requesting signal before the first cell can transmit a demanded SSB.

In one embodiment, an on-demand SSB is crucial for saving network power.

In one embodiment, the first SSB is not on demand, and SSBs in the first SSB group are actively transmitted by the network.

In one embodiment, the first SSB is not on demand, and SSBs in the first SSB group can be received without being demanded.

In one embodiment, the first SSB is not on demand, and to receive SSBs from the first SSB group, the first node does not need to transmit a requesting signal.

In one embodiment, the first signaling indicates the first SSB group through SSB-ToMeasure.

In one embodiment, SSBs indicated by SSB-ToMeasure consist of the first SSB group.

In one embodiment, the meaning of the first SSB group belonging to the first cell comprises: each SSB in the first SSB group belongs to the first cell.

In one embodiment, the meaning of the first SSB group belonging to the first cell comprises: the first SSB group is transmitted by the first cell.

In one embodiment, the meaning of the first SSB group belonging to the first cell comprises: the first signaling indicates the first cell, comprising the first SSB group indicating the first cell.

In one embodiment, the meaning of the first SSB group belonging to the first cell comprises: the first SSB group consists of SSBs of the first cell indicated by the first signaling.

In one embodiment, the meaning of the first SSB group belonging to the first cell comprises: the first SSB group consists of SSBs used for measurement or cell selection of the first cell indicated by the first signaling.

In one embodiment, the meaning of the phrase that the first SSB group is on demand is or comprises: a synchronization signal comprised in any SSB in the first SSB group is on demand.

In one embodiment, the meaning of the phrase that the first SSB group is on demand is or comprises: a signal on a PBCH comprised in any SSB in the first SSB group is on demand.

In one embodiment, the meaning of the phrase that the first SSB group is on demand is or comprises: an MIB comprised in any SSB in the first SSB group is on demand.

In one embodiment, the meaning of the phrase that the first SSB group is on demand is or comprises: an MIB transmitted on a PBCH comprised in any SSB in the first SSB group is on demand.

In one embodiment, the meaning of on demand is or comprises: when a demand signal is not received, the network may not transmit it.

In one embodiment, the meaning of on demand is or comprises: to receive, a requesting signal needs to be transmitted.

In one embodiment, a unit for measurement of the target time length is ms.

In one embodiment, the first value is different from the second value.

In one embodiment, the first value and second value are configured separately.

In one embodiment, the first value and second value are configured separately by two signalings.

In one subembodiment of the embodiment, advantages of the above method include: being more flexibility in implementation.

In one embodiment, the first signaling indicates that each SSB of the first cell is on demand.

In one embodiment, the first signaling does not indicate that an SSB of the first cell is on demand, and an SSB of the first cell is not on demand.

In one embodiment, the first signaling configures resources requesting SSBs of the first cell.

In one embodiment, when the first signaling does not indicate that an SSB of the first cell is on demand, the target time length is a second value.

In one embodiment, the first signaling indicates the first value.

In one embodiment, the first value is fixed.

In one embodiment, the first signaling indicates the second value.

In one embodiment, the second value is greater than the first value.

In one subembodiment of the embodiment, advantages of the above method include: a better evaluation of the SSB is based on quality of the requested cell, especially important when the extra signaling delay required by requesting an SSB makes it impossible to complete the evaluation of the first cell within a time length of a first value.

In one embodiment, both the first value and second value are positive integers.

In one embodiment, a unit for measurement of the target time length is ms.

In one embodiment, a unit for measurement of the target time length is s.

In one embodiment, a unit for measurement of the target time length is DRX (Discontinuous Reception) period.

In one embodiment, both the first value and the second value are not explicitly indicated by the network.

In one subembodiment of the embodiment, advantages of the above method include: simpler and clearer implementation.

In one embodiment, it is necessary to define a target time length to complete an evaluation of a cell, such as the first cell, to ensure the user experience, to ensure that a cell is selected in a timely manner, and to ensure that the network paging can be received in a timely manner.

In one embodiment, an SSB refers to, corresponds to, or occupies a certain amount of time-frequency resources.

In one embodiment, the meaning of evaluating a first cell comprises: measuring at least one SSB in the first SSB group to obtain a first measurement result; the first measurement result measures quality of the first cell.

In one subembodiment of the embodiment, measuring at least one SSB in the first SSB group comprises measuring one SSB in the first SSB group.

In one subembodiment of the embodiment, measuring at least one SSB in the first SSB group comprises measuring any SSB in the first SSB group.

In one subembodiment of the embodiment, measuring at least one SSB in the first SSB group comprises measuring all SSBs in the first SSB group.

In one subembodiment of the above embodiment, the first node determines which SSBs in the first SSB group to be measured based on implementation.

In one subembodiment of the above embodiment, the first node determines which SSBs in the first SSB group to be measured based on capabilities of the physical device.

In one subembodiment of the above embodiment, the first node measures an SSB first founded in the first SSB group, and if quality of the SSB first founded does not meet demand, then other SSBs in the first SSB group are measured.

In one subembodiment of the above embodiment, the first node is measured in order of SSBs in the first SSB group.

In one subembodiment of the above embodiment, the first node measures in order of SSBs in the first SSB group until an SSB that meets quality demand is found.

In one embodiment, the meaning of the phrase that the first measurement result measures quality of the first cell comprises: the first measurement result comprises RSRP (Reference Signal Receiving Power).

In one embodiment, the meaning of the phrase that the first measurement result measures quality of the first cell comprises: the first measurement result is an average of measurement results for multiple SSBs in the first SSB group.

In one embodiment, the meaning of the phrase that the first measurement result measures quality of the first cell comprises: the first measurement result is a best one among measurement results for SSBs in the first SSB group.

In one embodiment, the meaning of the phrase that the first measurement result measures quality of the first cell comprises: the first measurement result describes quality of the first cell.

In one embodiment, the meaning of the phrase that the first measurement result measures quality of the first cell comprises: if the first measurement result is large, then quality of the first cell is good; otherwise, quality of the first cell is poor.

In one embodiment, the meaning of the phrase that the first measurement result measures quality of the first cell comprises: if the first measurement result meets demand, then quality of the first cell is good; otherwise, quality of the first cell is poor.

In one subembodiment of the embodiment, the first signaling indicates the demand.

In one subembodiment of the embodiment, the first cell indicates the demand.

In one subembodiment of the above embodiment, the demand is fixed.

In one subembodiment of the above embodiment, the demand is configured by the core network or operator.

In one subembodiment of the above embodiment, meeting the demand means meeting a certain threshold.

In one embodiment, the meaning of evaluating a first cell comprises: evaluating quality of the first cell.

In one subembodiment of the embodiment, evaluating communication quality or radio channel quality of the first cell.

In one subembodiment of the embodiment, if quality of the first cell meets the demand, it can camp in the first cell.

In one subembodiment of the embodiment, quality of the first cell does not meet demand, it is not possible or best not to camp in the first cell.

In one subembodiment of the embodiment, if quality of the first cell meets demand, then the first cell is a suitable cell.

In one subembodiment of the embodiment, the first signaling indicates the demand.

In one subembodiment of the embodiment, the first cell indicates the demand.

In one subembodiment of the above embodiment, the demand is fixed.

In one subembodiment of the above embodiment, the demand is configured by the core network or operator.

In one subembodiment of the above embodiment, meeting the demand means meeting a certain threshold.

In one embodiment, the meaning of evaluating a first cell comprises: evaluating whether the first cell is a suitable cell.

In one embodiment, technicians in this field should understand that a suitable cell is a specific term in this field.

In one embodiment, the suitable cell is a cell where the UE can camp, for NR cells, certain conditions need to be met, which refer to chapter 4.5 of 3GPP TS 38.304.

In one embodiment, the meaning of evaluating a first cell comprises: determining Srxlev of the first cell, and whether the Srxlev of the first cell comprises a first offset depending on whether the first SSB group is on demand; when the first SSB group is on demand, the Srxlev of the first cell comprises a first offset; when the first SSB group is not on demand, the Srxlev of the first cell does not comprise a first offset.

In one subembodiment of the embodiment, the first node obtains the Srxlev of the first cell by measuring at least one SSB group in the first SSB group.

In one subembodiment of the embodiment, the first offset is non-zero.

In one subembodiment of the embodiment, the first offset is a negative number.

In one subembodiment of the embodiment, the Srxlev of the first cell comprising the first offset enables the first cell less likely to be selected.

In one subembodiment of the above embodiment, the first signaling indicates the first offset.

In one subembodiment of the above embodiment, the first cell indicates the first offset.

In one subembodiment of the embodiment, the first offset is fixed.

In one embodiment, the first node executing cell reselection comprises: determining Srxlev of the first cell, and whether the Srxlev of the first cell comprises a first offset depending on whether the first SSB group is on demand; when the first SSB group is on demand, the Srxlev of the first cell comprises a first offset; when the first SSB group is not on demand, the Srxlev of the first cell does not comprise a first offset.

In one subembodiment of the embodiment, the first node obtains the Srxlev of the first cell by measuring at least one SSB group in the first SSB group.

In one subembodiment of the embodiment, the first offset is non-zero.

In one subembodiment of the embodiment, the first offset is a negative number.

In one subembodiment of the embodiment, the Srxlev of the first cell comprising the first offset enables the first cell less likely to be selected.

In one subembodiment of the above embodiment, the first signaling indicates the first offset.

In one subembodiment of the above embodiment, the first cell indicates the first offset.

In one subembodiment of the embodiment, the first offset is fixed.

In one embodiment, the behavior of performing cell selection comprises: when no suitable cell is found within a time length of the first value, performing a cell evaluation within a time length of the second value; when a suitable cell is found within a time length of the first value, selecting the suitable cell.

In one subembodiment of the embodiment, the first node assumes that SSBs of the first SSB group are not on demand when performing cell evaluation.

In one subembodiment of the embodiment, the first node first performs cell evaluation based on the fact that none of SSBs in the first SSB group are on demand.

In one subembodiment of the embodiment, when the first node does not find a suitable cell within a time length of the first value, the first node considers that SSBs of the first SSB group are on demand.

In one subembodiment of the embodiment, when the first node does not find a suitable cell within a time length of the first value, the first node requests an SSB.

In one subembodiment of the embodiment, the meaning of the phrase that when no suitable cell is found within a time length of the first value, performing a cell evaluation within a time length of the second value comprises: when no suitable cell is found within a time length of the first value, performing cell evaluation again within a time length of the second value.

In one subembodiment of the embodiment, the meaning of the phrase that when no suitable cell is found within a time length of the first value, performing a cell evaluation within a time length of the second value comprises: when no suitable cell is found within a time length of the first value, extending a cell evaluation time from the first value to the second value.

In one subembodiment of the embodiment, advantages of the above method include: the first node adaptively determines a time for performing cell evaluation, which is more flexible.

In one embodiment, cell evaluation is evaluating a cell.

In one embodiment, cell evaluation is or comprises cell searching.

In one embodiment, selecting the suitable cell comprises camping on a selected cell.

### Embodiment 2

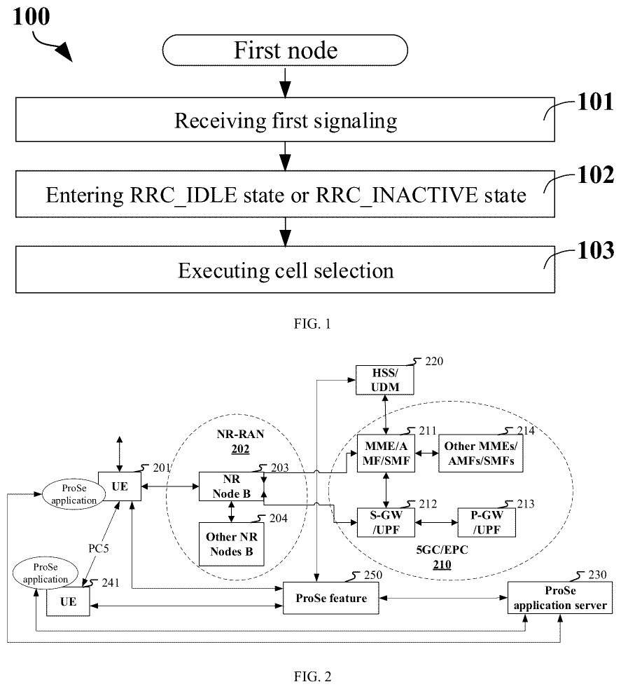

Embodiment 2 illustrates a schematic diagram of a network architecture according to the present application, as shown in FIG. 2.

FIG. 2 illustrates a network architecture 200 of 5G NR, Long-Term Evolution (LTE) and Long-Term Evolution Advanced (LTE-A) systems. The 5G NR or LTE network architecture 200 may be called a 5G System (5GS)/Evolved Packet System (EPS) 200 or other appropriate terms. The 5GS/EPS 200 may comprise one or more UEs 201, an NG-RAN 202, a 5G Core Network/Evolved Packet Core (5GC/EPC) 210, a Home Subscriber Server (HSS)/Unified Data Management (UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will readily understand that various concepts presented throughout the present application can be extended to networks providing circuit switching services or other cellular networks. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPS), multimedia devices, video devices, digital audio players (for example, MP3 players), cameras, game consoles, unmanned aerial vehicles (UAV), aircrafts, narrow-band Internet of Things (IoT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the first node in the present application is a UE 201.

In one embodiment, a base station of the second node in the present application is a gNB 203.

In one embodiment, a radio link between the UE 201 and NR node B is uplink.

In one embodiment, a radio link between NR node B and UE 201 is downlink.

In one embodiment, the UE 201 supports relay transmission.

In one embodiment, the UE 201 comprises a mobile phone.

In one embodiment, the UE 201 is a vehicle comprising a car.

In one embodiment, the gNB 203 is a MarcoCellular base station.

In one embodiment, the gNB 203 is a Micro Cell base station.

In one embodiment, the gNB 203 is a PicoCell base station.

In one embodiment, the gNB 203 is a flight platform.

In one embodiment, the gNB 203 is satellite equipment.

### Embodiment 3

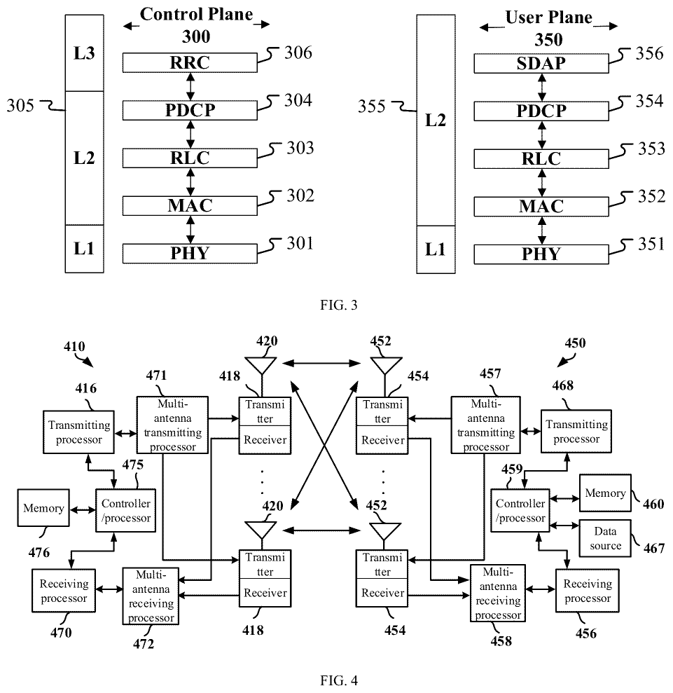

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a first node (UE, gNB or a satellite or an aircraft in NTN) and a second node (gNB, UE or a satellite or an aircraft in NTN), or between two UEs is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of a link between a first node and a second node, as well as two UEs via the PHY 301. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second node. The PDCP sublayer 304 provides multiplexing among variable radio bearers and logical channels. The PDCP sublayer 304 provides security by encrypting a packet and provides support for a first node handover between second nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with anRRC signaling between a second node and a first node. PC5 Signaling Protocol (PC5-S) sublayer 307 is responsible for the processing of signaling protocol at PC5 interface. The radio protocol architecture of the user plane 350 comprises layer 1 (L1) and layer 2 (L2). In the user plane 350, the radio protocol architecture for the first node and the second node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. SRB can be seen as a service or interface provided by the PDCP layer to a higher layer, such as the RRC layer. In NR system, SRB comprises SRB1, SRB2, SRB3, and when it comes to sidelink communications, there is also SRB4, which is respectively used to transmit different types of control signalings. SRB, a bearer between a UE and access network, is used to transmit a control signaling, comprising an RRC signaling, between UE and access network. SRB1 has special significance for a UE. After each UE establishes an RRC connection, there will be SRB1 used to transmit RRC signaling. Most of the signalings are transmitted through SRB1. If SRB1 is interrupted or unavailable, the UE must perform RRC reconstruction. SRB2 is generally used only to transmit an NAS signaling or signaling related to security aspects. UE cannot configure SRB3. Except for emergency services, a UE must establish an RRC connection with the network for subsequent communications. Although not described in the figure, the first node may comprise several higher layers above the L2 305. also comprises a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first signal in the present application is generated by the PHY 301 or MAC 302 or RRC 306.

In one embodiment, the first signaling in the present application is generated by the RRC 306.

In one embodiment, the first information in the present application is generated by the RRC 306.

In one embodiment, the SIB1 in the present application is generated by the RRC 306.

### Embodiment 4

Embodiment 4 illustrates a schematic diagram of a first communication device and a second communication device according to one embodiment of the present application, as shown in FIG. 4. FIG. 4 is a block diagram of a first communication device 450 in communication with a second communication device 410 in an access network.

The first communication device 450 comprises a controller/processor 459, a memory 460, a data source 467, a transmitting processor 468, a receiving processor 456, optionally may also comprise a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, optional can also comprise a multi-antenna receiving processor 472, a multi-antenna transmitting processor 471, a transmitter/receiver 418 and an antenna 420.

In a transmission from the second communication device 410 to the first communication device 450, at the first communication device 410, a higher layer packet from the core network is provided to a controller/processor 475. The controller/processor 475 provides a function of the L2 layer. In the transmission from the second communication device 410 to the first communication device 450, the controller/processor 475 provides header compression, encryption, packet segmentation and reordering, and multiplexing between a logical channel and a transport channel, and radio resources allocation for the first communication device 450 based on various priorities. The controller/processor 475 is also responsible for retransmission of a lost packet and a signaling to the first communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 410, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the second communication device 410 to the first communication device 450, at the second communication device 450, each receiver 454 receives a signal via a corresponding antenna 452. Each receiver 454 recovers information modulated to the RF carrier, converts the radio frequency stream into a baseband multi-carrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the first communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the second communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the second communication device 410 to the second communication device 450, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the first communication device 450 to the second communication device 410, at the second communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the second communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the first communication device 450 to the second communication device 410, the function at the second communication device 410 is similar to the receiving function at the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first communication device 450 comprises: at least one processor and at least one memory. The at least one memory comprises computer program codes; the at least one memory and the computer program codes are configured to be used in collaboration with the at least one processor, the first communication device 450 at least: receives a first signaling, the first signaling indicates releasing an RRC connection; as a response to receiving the first signaling, enters RRC_IDLE state or RRC_INACTIVE state, accompanying the behavior of entering RRC_IDLE state or RRC_INACTIVE state, executes cell selection; the behavior of executing cell selection comprises evaluating a first cell within a target time length; the target time length depends on whether a first SSB group is on demand; the first SSB group belongs to the first cell; herein, the meaning of the phrase that the target time length depends on whether an SSB of the first cell is on demand comprises: when an SSB of the first cell is on demand, the target time length is a first value; when an SSB of the first cell is not on demand, the target time length is a second value.

In one embodiment, the first communication device 450 comprises at least one processor and at least one memory. a memory that stores a computer readable instruction program. The computer readable instruction program generates an action when executed by at least one processor. The action includes: receiving a first signaling, the first signaling indicating releasing an RRC connection; as a response to receiving the first signaling, entering RRC_IDLE state or RRC_INACTIVE state; accompanying the behavior of entering RRC_IDLE state or RRC_INACTIVE state, executing cell selection; the behavior of executing cell selection comprising evaluating a first cell within a target time length; the target time length depending on whether a first SSB group is on demand; the first SSB group belonging to the first cell; herein, the meaning of the phrase that the target time length depends on whether an SSB of the first cell is on demand comprises: when an SSB of the first cell is on demand, the target time length is a first value; when an SSB of the first cell is not on demand, the target time length is a second value.

In one embodiment, the first communication device 450 corresponds to a first node in the present application.

In one embodiment, the second communication device 410 corresponds to a second node in the present application.

In one embodiment, the first communication device 450 is a UE.

In one embodiment, the first communication device 450 is a vehicle terminal.

In one embodiment, the second communication device 450 is a relay.

In one embodiment, the second communication device 410 is a satellite.

In one embodiment, the second communication device 410 is an aircraft.

In one embodiment, the second communication device 410 is a base station.

In one embodiment, the receiver 454 (comprising the antenna 452), the receiving processor 456 and the controller/processor 459 are used to receive the first signaling in the present application.

In one embodiment, the receiver 454 (comprising the antenna 452), the receiving processor 456 and the controller/processor 459 are used to receive the first information in the present application.

In one embodiment, the receiver 454 (comprising the antenna 452), the receiving processor 456 and the controller/processor 459 are used to receive the SIB1 in the present application.

In one embodiment, the transmitter 454 (comprising antenna 452), the transmitting processor 468 and the controller/processor 459 are used to transmit the first signal in the present application.

### Embodiment 5

Embodiment 5 illustrates a flowchart of radio signal transmission according to one embodiment in the present application, as shown in FIG. 5. In FIG. 5, U01 corresponds to a first node in the present application. It is particularly underlined that the order illustrated in the embodiment does not put constraints over sequences of signal transmissions and implementations and steps in F51 are optional.

The first node U01 receives third information in step S20; enters RRC_IDLE state or RRC_INACTIVE state in step S5102; executes cell selection in step S5103; monitors a paging in step S5104; transmits a first signal in step S5105; receives an SSB in step S5106; starts measurements on all neighboring cells in step S5107.

The second node U02 transmits a first signaling in step S5201; receives a first signal in step S5202; transmits an SSB in step S5202.

In embodiment 5, the first signaling indicates a release of RRC connection; as a response to receiving the first signaling, the first node U01 executes step S5102, accompanying step S5102, the first node executes step S5103; the behavior of executing cell selection comprises evaluating the first cell within a target time length; the target time length depends on whether a first SSB group is on demand; the first SSB group belongs to the first cell; herein, the meaning of the phrase that the target time length depends on whether an SSB of the first cell is on demand comprises: when an SSB of the first cell is on demand, the target time length is a first value; when an SSB of the first cell is not on demand, the target time length is a second value.

In one embodiment, the second node U02 is an SpCell of the first node U01.

In one embodiment, the second node U02 is an MCG of the first node U01.

In one embodiment, the second node U02 is the first cell.

In one embodiment, the second node U02 is a base station corresponding to a PCell of the first node U01 or a PCell.

In one embodiment, a communication interface between the first node U01 and the second node U02 is a Uu interface.

In one embodiment, step S5102 depends on step S5101.

In one embodiment, step S5103 depends on step S5101.

In one embodiment, step S5102 is after step S5101.

In one embodiment, step S5103 and step S5102 do not require a definite chronological relation, for example, the two steps can occur simultaneously.

In one embodiment, step S5104 is after step S5103.

In one embodiment, step S5105 is after step S5103.

In one embodiment, step S5106 is after step S5105.

In one embodiment, step S5105 triggers step S5106.

In one embodiment, step S5107 is after step S5203.

In one embodiment, the second node U02 belongs to NR network.

In one embodiment, an RRC connection is established between networks to which the first node U01 and the second node U02 belong.

In one subembodiment of the above embodiment, the RRC connection is released upon the first signaling is received.

In one embodiment, regardless of whether the first node enters RRC_IDLE state or RRC_INACTIVE state, the first signaling comprises: frequency information, where the first node performs cell selection on frequency indicated by the frequency information.

In one embodiment, regardless of whether the first node enters RRC_IDLE state or RRC_INACTIVE state, the first signaling comprises: measurement configuration.

In one subembodiment of the embodiment, the measurement configuration is for network optimization.

In one embodiment, the first signaling comprises a first field, the first field is suspendConfig, the first signaling comprising the first field indicates that the first node U01 enters RRC_INACTIVE state, the first field indicates at least one of an I-RNTI of the first node U01, a paging cycle of RAN, a value of t380 timer, RAN notification area information, or SDT configuration.

In one subembodiment of the embodiment, the I-RNTI identifies a suspended UE context of UE in RRC_INACTIVE state.

In one subembodiment of the embodiment, the t380 timer is started periodically, and the t380 is activated when entering RRC_INACTIVE state, and an expiration of the t380 triggers an initiation of RAN area update.

In one subembodiment of the embodiment, the RAN notification area information is within an indicated RAN notification area, and the first node U01 does not need to initiate an RAN area update; when entering a new RAN notification area, the first node U01 needs to initiate an RAN area update.

In one subembodiment of the embodiment, the SDT (small data transmission) configuration comprises configuring resources for transmitting SDT data.

In one subembodiment of the embodiment, the first signaling indicates the first cell.

In one subembodiment of the embodiment, the first signaling indicates the first SSB group.

In one subembodiment of the embodiment, the first signaling indicates that the first SSB group is on demand; the first node U01 evaluates the first cell within the target time length; and the target time length is a second value.

In one subembodiment of the embodiment, after evaluation the first cell is found to be a suitable cell, the first node U01 selects the first cell.

In one embodiment, the first signaling comprises a first field, the first field is suspendConfig, the first signaling comprising the first field indicates that the first node U01 enters RRC_INACTIVE state, the first field indicates at least one of an I-RNTI of the first node U01, a paging cycle of RAN, a value of t380 timer, RAN notification area information, or SDT configuration.

In one subembodiment of the embodiment, the I-RNTI identifies a suspended UE context of UE in RRC_INACTIVE state.

In one subembodiment of the embodiment, the t380 timer is started periodically, and the t380 is activated when entering RRC_INACTIVE state, and an expiration of the t380 triggers an initiation of RAN area update.

In one subembodiment of the embodiment, the RAN notification area information is within an indicated RAN notification area, and the first node U01 does not need to initiate an RAN area update; when entering a new RAN notification area, the first node U01 needs to initiate a RAN area update.

In one subembodiment of the embodiment, the SDT (small data transmission) configuration comprises configuring resources for transmitting SDT data.

In one subembodiment of the embodiment, the first cell is any candidate cell in cell selection.

In one subembodiment of the embodiment, the first SSB group consists of all SSBs in the first cell.

In one subembodiment of the embodiment, the first SSB group consists of all founded or detected SSBs in the first cell.

In one subembodiment of the embodiment, the first signaling indicates that the first SSB group is not on demand; the first node U01 evaluates the first cell within the target time length; and the target time length is a first value.

In one subembodiment of the embodiment, after evaluation the first cell is found to be a suitable cell, the first node U01 selects the first cell.

In one embodiment, the first signaling does not comprise a first field, the first field is suspendConfig, and the first signaling does not comprise the first field then the first node U01 enters RRC_IDLE state.

In one subembodiment of the embodiment, the first signaling indicates the first cell.

In one subembodiment of the embodiment, the first signaling indicates the first SSB group.

In one subembodiment of the embodiment, the first signaling indicates that the first SSB group is on demand; the first node U01 evaluates the first cell within the target time length; and the target time length is a second value.

In one subembodiment of the embodiment, the first cell is found to be a suitable cell after evaluation, the first node U01 selects the first cell.

In one embodiment, the first signaling does not comprise a first field, the first field is suspendConfig, and the first signaling does not comprise the first field then the first node U01 enters RRC_IDLE state.

In one subembodiment of the embodiment, the first cell is any candidate cell in cell selection.

In one subembodiment of the embodiment, the first SSB group consists of all SSBs in the first cell.

In one subembodiment of the embodiment, the first SSB group consists of all founded or detected SSBs in the first cell.

In one subembodiment of the embodiment, the first signaling indicates that the first SSB group is not on demand; the first node U01 evaluates the first cell within the target time length; and the target time length is a first value.

In one subembodiment of the embodiment, after evaluation the first cell is found to be a suitable cell, the first node U01 selects the first cell.

In one embodiment, the first node U01 monitors a paging on at least one time-frequency resource, and the at least one time-frequency resource depends on whether the first SSB group is on demand.

In one subembodiment of the embodiment, when the first SSB group is not on demand, the at least one time-frequency resource comprises K time-frequency resources within a time length of each first value, where K is greater than 0; when the first SSB group is not on demand, the at least one time-frequency resource comprises K time-frequency resources within a time length of each second value, where K is greater than 0.

In one subembodiment of the embodiment, compared to when the first SSB group is not on demand, when the first SSB group is on demand, the at least one time-frequency resource comprises fewer time-frequency resources.

In one subembodiment of the embodiment, compared to when the first SSB group is not on demand, when the first SSB group is on demand, the at least one time-frequency resource is more concentrated in time domain.

In one subembodiment of the embodiment, compared to when the first SSB group is on demand, when the first SSB group is not on demand, the at least one time-frequency resource is more dispersed in time domain.

In one subembodiment of the embodiment, benefits of the above methods include: being able to save more network power; it also helps to save power for UE.

In one embodiment, the first node U01, as a response to the first condition being met, executes step S5105.

In one subembodiment of the above embodiment, the first signal requests an SSB of the first cell.

In one subembodiment of the above embodiment, the first condition comprises failure to receive an SSB of the first cell within a time length of a first value.

In one subembodiment of the above embodiment, the first condition comprises failure to detect an SSB of the first cell within a time length of the first value.

In one subembodiment of the above embodiment, the first condition comprises failure to receive or detect an SSB in the first SSB group within a time length of a first value.

In one subembodiment of the embodiment, the first SSB group is on demand.

In one subembodiment of the above embodiment, the first signal comprises a physical-layer signal.

In one subembodiment of the above embodiment, the first signal is or comprises a signal transmitted on a PRACH (physical random access channel).

In one subembodiment of the above embodiment, the first signal is or comprises a Preamble signal.

In one subembodiment of the above embodiment, the first signal is or comprises an msg3 in a 4-step random access procedure.

In one subembodiment of the above embodiment, the first signal is or comprises an MSGA in a 2-step random access procedure.

In one embodiment, the first node U01, as a response to the second condition being met, executes step S5105.

In one subembodiment of the above embodiment, the first signal requests an SSB of the first cell.

In one subembodiment of the above embodiment, the first condition comprising the second condition comprises failure to found a suitable cell within a time length of a third value.

In one subembodiment of the above embodiment, the first condition comprising the second condition comprises failure to complete an evaluation of the first cell within a time length of a third value.

In one subembodiment of the embodiment, the first SSB group is on demand.

In one subembodiment of the above embodiment, the first signal comprises a physical-layer signal.

In one subembodiment of the above embodiment, the first signal is or comprises a signal transmitted on a PRACH (physical random access channel).

In one subembodiment of the above embodiment, the first signal is or comprises a preamble signal.

In one subembodiment of the above embodiment, the first signal is or comprises an msg3 in a 4-step random access procedure.

In one subembodiment of the above embodiment, the first signal is or comprises an MSGA in a 2-step random access procedure.

In one subembodiment of the embodiment, the first signaling indicates the third value.

In one subembodiment of the embodiment, the first cell indicates the third value.

In one subembodiment of the above embodiment, the third value is fixed.

In one subembodiment of the above embodiment, the third value depends on the first value or the third value depends on the second value.

In one embodiment, the first node U01 receives an SSB of the first cell in step S5106.

In one subembodiment of the above embodiment, in this embodiment, the second node U02 is the first cell, but this application does not limit that the first cell can be a cell other than the second node U02, that is, an SSB received by the first node U01 in step S5106 is transmitted by a cell other than the second node U02.

In one embodiment, step S5107 is executed after the first node U01 completes cell selection.

In one subembodiment of the above embodiment, the first node U01 selects the first cell in cell selection.

In one embodiment, when the first cell does not meet the S criterion within a first time length, the first node U01 starts measuring all neighboring cells.

In one subembodiment of the embodiment, the first time length depends on whether the first SSB group is on demand.

In one embodiment, system information broadcasted by the second node U02 indicates all neighboring cells.

In one embodiment, system information broadcasted by a cell where the first node U01 camps indicates the all neighboring cells.

In one embodiment, system information stored in the first node U01 indicates the all neighboring cells.

In one embodiment, measurements for all neighboring cells are initiated to quickly identify a suitable cell.

In one embodiment, not satisfying the S criteria indicates that a current community is no longer suitable.

In one embodiment, compared to the first SSB group not being on demand, the first time length is longer when the first SSB group is on demand.

In one embodiment, when the first SSB group is not on demand, the first time length is a positive integer multiple of a first value; when the first SSB group is on demand, the first time length is a positive integer multiple of the second value.

In one embodiment, the first signaling is not a system information block.

In one embodiment, the meaning of the phrase that the first node selects the first cell is: the first cell is a cell where the first node camps.

In one embodiment, the meaning of the phrase that the first node selects the first cell is: the first cell is a serving cell of the first node.

### Embodiment 6

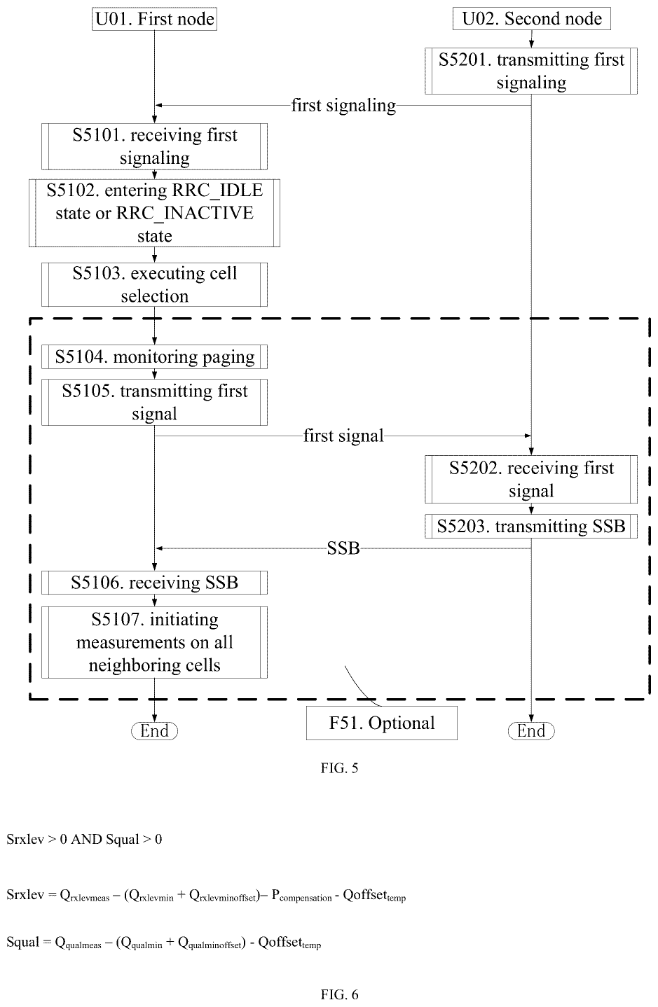

Embodiment 6 illustrates a schematic diagram of cell evaluation according to one embodiment of the present application, as shown in FIG. 6.

In one embodiment, FIG. 6 shows S criterion for cell selection, which is satisfied when the formula in FIG. 6 is satisfied.

In one embodiment, Srxlev in FIG. 6 is an RX level value for cell selection, which is measured in dB.

In one embodiment, Squal in FIG. 6 is a quality value for cell selection, which is measured in dB.

In one embodiment, Qoffsetₜₑₘₚ in FIG. 6 is a temporary offset applied to a cell, which is measured in dB.

In one subembodiment of the embodiment, the Qoffsetₜₑₘₚ is indicated by the network.

In one subembodiment of the embodiment, when consecutive connection establishment failures occur, the Qoffsetₜₑₘₚ is applied.

In one embodiment, Qᵣₓₗₑᵥₘₑₐₛ in FIG. 6 is a measured cell RX level value, i.e. RSRP.

In one embodiment, Q_{qualmeas} in FIG. 6 is a measured cell quality value, i.e. RSRQ.

In one embodiment, Qᵣₓₗₑᵥₘᵢₙ in FIG. 6 is a minimum required RX level value.

In one subembodiment of the embodiment, the Qᵣₓₗₑᵥₘᵢₙ is indicated by network, such as through system information block.

In one subembodiment of the embodiment, the Qᵣₓₗₑᵥₘᵢₙ is indicated by the first signaling.

In one embodiment, Q_{qualmin} in FIG. 6 is a minimum required quality level, which is measured in dB.

In one subembodiment of the embodiment, the Q_{qualmin} is indicated by network, such as through system information block.

In one subembodiment of the embodiment, the Q_{qualmin} is indicated by the first signaling.

In one embodiment, Q_{rxlevminoffset} in FIG. 6 is an offset applied to Qᵣₓₗₑᵥₘᵢₙ.

In one embodiment, Q_{qualminoffset} in FIG. 6 is an offset applied to Q_{qualmin}.

In one embodiment, P_{compensation} in FIG. 6 is for FR1, that is, for FR2, P_{compensation} is 0.

In one embodiment, when P_{compensation} is indicated by SIB1, SIB2, and SIB4 in FIG. 6, it satisfies max max(P_{EMAX1}−P_{PowerClass}, 0)−(min(P_{EMAX2}, P_{PowerClass})−min(P_{EMAX1}, P_{PowerClass})); When P_{compensation} is indicated by a signaling other than SIB1, SIB2, and SIB4, P_{compensation} satisfies max (P_{EMAX1}−P_{PowerClass}, 0); where max ( ) is an operation of taking a maximum value, and min( ) is an operation of taking a minimum value; P_{EMAX1} and P_{EMAX2} are maximum transmit power that UE can use for uplink transmission in a cell, defined by 3GPP TS 38.101-1; P_{PowerClass} is maximum RF transmit power of a UE based on its power level, measured in dBm, for detailed definition of P_{PowerClass}, refer to 3GPP TS 38.101-1.

In one embodiment, P_{compensation} is only used when the first node supports extra maximum transmit power.

In one embodiment, Q_{rxlevminoffset} and Q_{qualminoffset} are only used for cell evaluation in cell selection during periodically searching for higher-priority PLMNs.

In one embodiment, a suitable cell must meet the S criterion.

In one embodiment, when the first SSB group is on demand, the Srxlev also comprises a first offset, the first offset is non-zero.

In one subembodiment of the above embodiment, when the first SSB group is not on demand, the Srxlev comprises a first offset, and the first offset is equal to 0.

In one embodiment, when the first SSB group is on demand, the Squal also comprises a first offset, the first offset is non-zero.

In one subembodiment of the above embodiment, when the first SSB group is not on demand, the Squal comprises a first offset, and the first offset is equal to 0.

In one embodiment, advantages of the above method include: helping the UE to preferentially select the cell that can receive SSBs without a request when selecting the cell, which helps to reduce the delay of cell selection and avoid missing paging.

### Embodiment 7

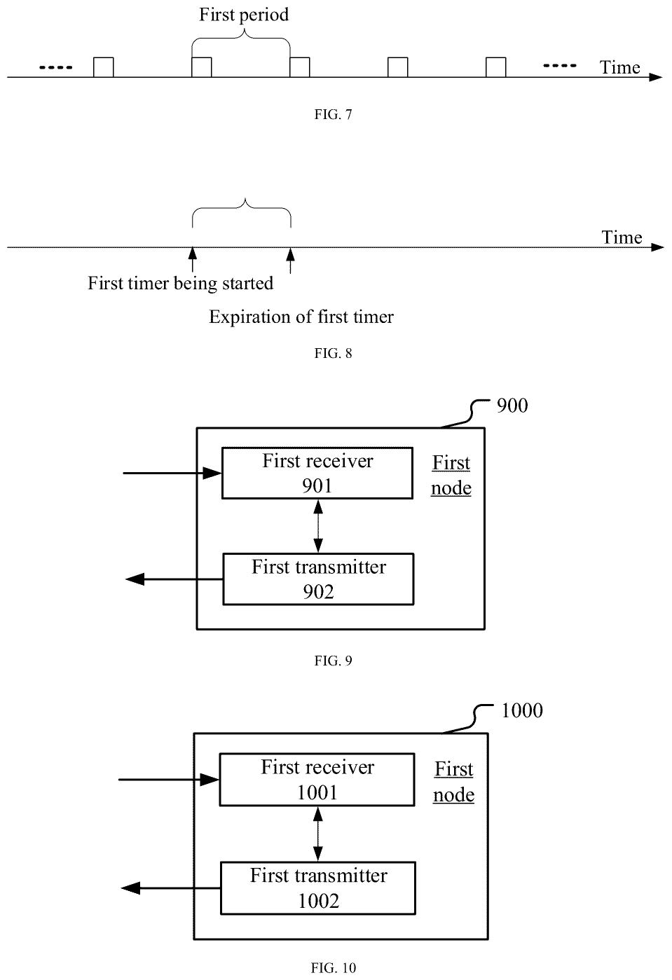

Embodiment 7 illustrates a schematic diagram of a first period according to one embodiment of the present application, as shown in FIG. 7.

In one embodiment, each small grid in FIG. 7 represents a resource for requesting SSB, the resource for requesting the SSB is periodic and the period is a first period.

In one subembodiment of the embodiment, the first signaling indicates the first period.

In one subembodiment of the above embodiment, the first signaling is used to demand resources for the SSB.

In one subembodiment of the above embodiment, the first signaling respectively indicates resources for demanding each SSB in the first SSB group.

In one subembodiment of the above embodiment, resources used to request each SSB in the first SSB group are the same.

In one subembodiment of the above embodiment, the demand SSB is to demand an SSB in the first SSB group.

In one subembodiment of the above embodiment, the SSB is an SSB in the first SSB group.

In one subembodiment of the above embodiment, the SSB is any SSB in the first SSB group.

In one subembodiment of the above embodiment, the first information indicates resources used to demand the SSB.

In one subembodiment of the above embodiment, the first node is only allowed to transmit a signal to request an SSB on configured resources used for requesting SSBs.

In one embodiment, a period of resources requesting SSBs comprised in the first SSB group is the first period.

In one subembodiment of the above embodiment, the SSB comprised in the first SSB group is any SSB in the first SSB group.

In one embodiment, the second value depends on the first period.

In one embodiment, the second value is equal to the first period.

In one embodiment, the second value is equal to a larger one of the first period and a second time length of the first node.

In one embodiment, the second value is not less than N1 times the first period, where N1 is a positive integer.

In one subembodiment of the embodiment, the N1 depends on whether operating frequency is FR1 or FR2, when the operating frequency is FR1, N1 is equal to 1, and when the operating frequency is FR2, N1 is not equal to 1.

In one embodiment, the second value is not less than N1 times a larger one of the first period and a second time length of the first node, where N1 is a positive integer.

In one subembodiment of the embodiment, the N1 depends on whether operating frequency is FR1 or FR2, when the operating frequency is FR1, N1 is equal to 1, and when the operating frequency is FR2, N1 is not equal to 1.

In one embodiment, the second value is not less than M2 times the first period, where M2 is a positive integer.

In one subembodiment of the above embodiment, M2 is equal to 2.

In one subembodiment of the above embodiment, M2 is equal to 4.

In one embodiment, the second value is not less than M2 times a larger one of the first period and a second time length of the first node, where M2 is a positive integer.

In one subembodiment of the above embodiment, M2 is equal to 2.

In one subembodiment of the above embodiment, M2 is equal to 4.

In one embodiment, the second time length is a DRX period of the first node.

In one embodiment, the second time length is a value of a first timer of the first node.

In one embodiment, the second time length is a larger one of a value of a first timer of the first node and a DRX period of the first node.

In one embodiment, benefits of the above method include: averaging more than 1 measurement value facilitates more accurate results, so the number of measurement results that can be obtained by estimating the number of SSBs that can be received according to the period of the resource that can be requested facilitates obtaining a sufficient number of measurement results for cell evaluation to be more accurate, and at the same time not being evaluated on a single cell for an excessively long period of time, which would interfere with the evaluation of other cells.

### Embodiment 8

Embodiment 8 illustrates a schematic diagram of a first timer according to one embodiment of the present application.

In one embodiment, during a running period of the first timer, the first node does not allow transmitting a signal requesting an SSB.

In one embodiment, a serving cell of the first node indicates a value of the first timer.

In one embodiment, the first signaling indicates a value of the first timer.

In one embodiment, the first information indicates a value of the first timer.

In one embodiment, a value of the first timer is greater than 0.

In one embodiment, the first timer is periodically started.

In one embodiment, the first timer is stopped when entering RRC_CONNECTED state.

In one embodiment, the first timer is started when entering RRC_IDLE state.

In one embodiment, the first timer is started when entering RRC_INACTIVE state.

In one embodiment, when the first timer is not running, the first node is allowed to transmit a signal requesting an SSB.

In one embodiment, the first timer is not T350.

In one embodiment, the first timer is for a cell.

In one embodiment, the first timer is for all cells using on-demand SSBs.

In one embodiment, benefits of the above method include: restricting the first node from requesting SSB, which is beneficial for network power saving.

### Embodiment 9

Embodiment 9 illustrates a structure block diagram of a processor in a first node according to one embodiment of the present application, as shown in FIG. 9. In FIG. 9, a processor 900 of a first node comprises a first receiver 901 and a first transmitter 902. In Embodiment 9,
a first receiver 901 receives a first signaling, and the first signaling indicates releasing an RRC connection; as a response to receiving the first signaling, enters RRC_IDLE state or RRC_INACTIVE state, and accompanying the behavior of entering RRC_IDLE state or RRC_INACTIVE state, executes cell selection; the behavior of executing cell selection comprises evaluating a first cell within a target time length; the target time length depends on whether a first SSB group is on demand; the first SSB group belongs to the first cell;
herein, the meaning of the phrase that the target time length depends on whether an SSB of the first cell is on demand comprises: when an SSB of the first cell is on demand, the target time length is a first value; when an SSB of the first cell is not on demand, the target time length is a second value.

In one embodiment, the meaning of evaluating a first cell comprises: measuring at least one SSB in the first SSB group to obtain a first measurement result; the first measurement result measures quality of the first cell.

In one embodiment, the meaning of evaluating a first cell comprises: determining Srxlev of the first cell, and whether the Srxlev of the first cell comprises a first offset depending on whether the first SSB group is on demand; when the first SSB group is on demand, the Srxlev of the first cell comprises a first offset; when the first SSB group is not on demand, the Srxlev of the first cell does not comprise a first offset.

In one embodiment, the behavior of performing cell selection comprises: when no suitable cell is found within a time length of the first value, performing a cell evaluation within a time length of the second value; when a suitable cell is found within a time length of the first value, selecting the suitable cell.

In one embodiment, the second value depends on a period of resources requesting SSBs comprised in the first SSB group.

In one embodiment, a first receiver 901 monitors a paging on at least one time-frequency resource; the at least one time-frequency resource depends on whether the first SSB group is on demand.

In one embodiment, a first transmitter 902, as a response to a first condition being satisfied, transmits a first signal, the first signal requests an SSB of the first cell; the first receiver 901 receives an SSB of the first cell; herein, the first condition comprises failure to receive an SSB of the first cell within a time length of a first value.

In one embodiment, a first transmitter 902, as a response to a second condition being satisfied, transmits a first signal, the first signal requests an SSB of the first cell; the first receiver 901 receives an SSB of the first cell; herein, the second condition comprises failure to found a suitable cell within a time length of a third value.

In one embodiment, the first receiver 901, as a response to the first cell not meeting S criterion within a first time length, initiates measurements on all neighboring cells; the first time length depends on whether the first SSB group is on demand; herein, the first node selects the first cell.

In one embodiment, the first node is a UE.

In one embodiment, the first node is a terminal that supports NTN.

In one embodiment, the first node is an aircraft or vessel.

In one embodiment, the first node is a mobile phone or vehicle terminal.

In one embodiment, the first node is a relay UE and/or U2N remote UE.

In one embodiment, the first node is an Internet of Things terminal or an Industrial Internet of Things terminal.

In one embodiment, the first node is a device that supports transmission with low-latency and high-reliability.

In one embodiment, the first receiver 901 comprises at least one of the antenna 452, the receiver 454, the receiving processor 456, the multi-antenna receiving processor 458, the controller/processor 459, the memory 460 or the data source 467 in Embodiment 4.

In one embodiment, the first transmitter 902 comprises at least one of the antenna 452, the transmitter 454, the transmitting processor 468, the multi-antenna transmitting processor 457, the controller/processor 459, the memory 460 or the data source 467 in Embodiment 4.

### Embodiment 10

Embodiment 10 illustrates a structure block diagram of a processor in a first node according to one embodiment of the present application, as shown in FIG. 10. In FIG. 10, a processor 1000 in a first node comprises a first receiver 1001 and a first transmitter 1002. In Embodiment 10,
a first receiver 1001 receives first information, and the first information is broadcast; the first information indicates at least one first cell; executes cell reselection; the behavior of executing cell reselection comprises evaluating the first cell within a target time length; the target time length depends on whether a first SSB group is on demand; the first SSB group belongs to the first cell;
herein, the meaning of the phrase that the target time length depends on whether an SSB of the first cell is on demand comprises: when an SSB of the first cell is on demand, the target time length is a first value; when an SSB of the first cell is not on demand, the target time length is a second value.

In one embodiment, the first information comprises a system information block.

In one embodiment, the first information comprises one of SIB1, SIB2, SIB3, SIB4, SIB5.

In one embodiment, an adjacent cell list comprised in the first information comprises the first cell.

In one embodiment, the first cell is a neighboring cell.

In one embodiment, the first information is not an SSB.

In one embodiment, problems to be solved by the above methods are: how to determine a target evaluation time in cell reselection.

In one embodiment, advantages of the above method are: in cell reselection, it can better support cells that adopt on-demand SSBs; it can complete cell evaluation without spending too much time on an evaluation of a cell.

In one embodiment, the meaning of evaluating a first cell comprises: measuring at least one SSB in the first SSB group to obtain a first measurement result; the first measurement result measures quality of the first cell.

In one embodiment, the meaning of evaluating a first cell comprises: determining Srxlev of the first cell, and whether the Srxlev of the first cell comprises a first offset depending on whether the first SSB group is on demand; when the first SSB group is on demand, the Srxlev of the first cell comprises a first offset; when the first SSB group is not on demand, the Srxlev of the first cell does not comprise a first offset.

In one embodiment, the behavior of performing cell reselection comprises: when no suitable cell is found within a time length of the first value, performing a cell evaluation within a time length of the second value; when a suitable cell is found within a time length of the first value, selecting the suitable cell.

In one embodiment, the second value depends on a period of resources requesting SSBs comprised in the first SSB group.

In one embodiment, the first receiver 1001 monitors a paging on at least one time-frequency resource; the at least one time-frequency resource depends on whether the first SSB group is on demand.

In one embodiment, the first transmitter 1002, as a response to a first condition being satisfied, transmits a first signal, the first signal requests an SSB of the first cell; the first receiver 1001 receives an SSB of the first cell; herein, the first condition comprises failure to receive an SSB of the first cell within a time length of a first value.

In one embodiment, the first transmitter 1002, as a response to a second condition being satisfied, transmits a first signal, the first signal requests an SSB of the first cell; the first receiver 1001 receives an SSB of the first cell; herein, the second condition comprises failure to found a suitable cell within a time length of a third value.

In one embodiment, the first receiver 1001, as a response to the first cell not meeting S criterion within a first time length, initiates a measurement of all neighboring cells; the first time length depends on whether the first SSB group is on demand; herein, the first node selects the first cell.

In one embodiment, the first node is a UE.

In one embodiment, the first node is a terminal that supports NTN.

In one embodiment, the first node is an aircraft or vessel.

In one embodiment, the first node is a mobile phone or vehicle terminal.

In one embodiment, the first node is a relay UE and/or U2N remote UE.

In one embodiment, the first node is an Internet of Things terminal or an Industrial Internet of Things terminal.

In one embodiment, the first node is a device that supports transmission with low-latency and high-reliability.

In one embodiment, the first receiver 1001 comprises at least one of the antenna 452, the receiver 454, the receiving processor 456, the multi-antenna receiving processor 458, the controller/processor 459, the memory 460 or the data source 467 in Embodiment 4.

In one embodiment, the first transmitter 1002 comprises at least one of the antenna 452, the transmitter 454, the transmitting processor 468, the multi-antenna transmitting processor 457, the controller/processor 459, the memory 460 or the data source 467 in Embodiment 4.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The UE and terminal in the present application include but not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things, RFID terminals, NB-IoT terminals, Machine Type Communication (MTC) terminals, enhanced MTC (eMTC) terminals, data cards, low-cost mobile phones, low-cost tablet computers, satellite communication equipment, vessel communication equipment, NTN UEs, etc. The base station or system device in the present application includes but is not limited to macro-cellular base stations, micro-cellular base stations, home base stations, relay base station, gNB (NR node B), Transmitter Receiver Point (TRP), NTN base stations, satellite equipment, flight platform equipment and other radio communication equipment.

This application can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first signaling, the first signaling indicating releasing an RRC connection; as a response to receiving the first signaling, entering RRC_IDLE state or RRC_INACTIVE state; accompanying the entering RRC_IDLE state or RRC_INACTIVE state, executing cell selection; the executing cell selection comprises evaluating a first cell within a target time length; the target time length depending on whether a first Synchronization Signal and PBCH block (SSB) group is on demand; the first SSB group belonging to the first cell;
wherein the meaning of the target time length depending on whether an SSB of the first cell is on demand comprises: when an SSB of the first cell is on demand, the target time length is a first value; when an SSB of the first cell is not on demand, the target time length is a second value.

2. The first node according to claim 1, wherein
the meaning of evaluating a first cell comprises: measuring at least one SSB in the first SSB group to obtain a first measurement result; the first measurement result measures quality of the first cell.

3. The first node according to claim 1, wherein
the meaning of the evaluating a first cell comprises: determining Srxlev of the first cell, and whether the Srxlev of the first cell comprises a first offset depending on whether the first SSB group is on demand; when the first SSB group is on demand, the Srxlev of the first cell comprises a first offset; when the first SSB group is not on demand, the Srxlev of the first cell does not comprise a first offset.

4. The first node according to claim 2, wherein
the meaning of evaluating a first cell comprises: determining Srxlev of the first cell, and whether the Srxlev of the first cell comprises a first offset depending on whether the first SSB group is on demand; when the first SSB group is on demand, the Srxlev of the first cell comprises a first offset; when the first SSB group is not on demand, the Srxlev of the first cell does not comprise a first offset.

5. The first node according to claim 1, wherein
the executing cell selection comprises: when no suitable cell is found within a time length of the first value, performing a cell evaluation within a time length of the second value; when a suitable cell is found within a time length of the first value, selecting the suitable cell.

6. The first node according to claim 4, wherein
the executing cell selection comprises: when no suitable cell is found within a time length of the first value, performing a cell evaluation within a time length of the second value; when a suitable cell is found within a time length of the first value, selecting the suitable cell.

7. The first node according to claim 1, wherein
the second value depends on a period of resources requesting SSBs comprised in the first SSB group.

8. The first node according to claim 1, comprising:
a first receiver, monitoring a paging on at least one time-frequency resource; the at least one time-frequency resource depending on whether the first SSB group is on demand.

9. The first node according to claim 1, comprising:
a first transmitter, as a response to a first condition being satisfied, transmitting a first signal, the first signal requesting an SSB of the first cell; and
the first receiver, receiving an SSB of the first cell;
wherein the first condition comprises failure to receive an SSB of the first cell within a time length of a first value.

10. The first node according to claim 1, comprising:
a first transmitter, as a response to a second condition being satisfied, transmitting a first signal, the first signal requesting an SSB of the first cell; and
the first receiver, receiving an SSB of the first cell;
wherein the second condition comprises failure to found a suitable cell within a time length of a third value.

11. The first node according to claim 3, comprising:
a first transmitter, as a response to a second condition being satisfied, transmitting a first signal, the first signal requesting an SSB of the first cell; and
the first receiver, receiving an SSB of the first cell;
wherein the second condition comprises failure to found a suitable cell within a time length of a third value.

12. The first node according to claim 5, comprising:
a first transmitter, as a response to a second condition being satisfied, transmitting a first signal, the first signal requesting an SSB of the first cell; and
the first receiver, receiving an SSB of the first cell;
wherein the second condition comprises failure to found a suitable cell within a time length of a third value.

13. The first node according to claim 1, comprising:
the first receiver, as a response to the first cell not meeting S criterion within a first time length, initiating measurements on all neighboring cells; the first time length depending on whether the first SSB group is on demand;
wherein the first node selects the first cell.

14. The first node according to claim 2, comprising:
the first receiver, as a response to the first cell not meeting S criterion within a first time length, initiating measurements on all neighboring cells; the first time length depending on whether the first SSB group is on demand;
wherein the first node selects the first cell.

15. The first node according to claim 4, comprising:
the first receiver, as a response to the first cell not meeting S criterion within a first time length, initiating measurements on all neighboring cells; the first time length depending on whether the first SSB group is on demand;
wherein the first node selects the first cell.

16. The first node according to claim 5, comprising:
the first receiver, as a response to the first cell not meeting S criterion within a first time length, initiating measurements on all neighboring cells; the first time length depending on whether the first SSB group is on demand;
wherein the first node selects the first cell.

17. A method in a first node for wireless communications, comprising:
receiving a first signaling, the first signaling indicating releasing an RRC connection; as a response to receiving the first signaling, entering RRC_IDLE state or RRC_INACTIVE state; accompanying the entering RRC_IDLE state or RRC_INACTIVE state, executing cell selection; the executing cell selection comprises evaluating a first cell within a target time length; the target time length depending on whether a first SSB group is on demand; the first SSB group belonging to the first cell;
wherein the meaning of the target time length depending on whether an SSB of the first cell is on demand comprises: when an SSB of the first cell is on demand, the target time length is a first value; when an SSB of the first cell is not on demand, the target time length is a second value.

18. The method in a first node according to claim 17, wherein
the meaning of evaluating a first cell comprises: determining Srxlev of the first cell, and whether the Srxlev of the first cell comprises a first offset depending on whether the first SSB group is on demand; when the first SSB group is on demand, the Srxlev of the first cell comprises a first offset; when the first SSB group is not on demand, the Srxlev of the first cell does not comprise a first offset.

19. The method in a first node according to claim 17, wherein
the executing cell selection comprises: when no suitable cell is found within a time length of the first value, performing a cell evaluation within a time length of the second value; when a suitable cell is found within a time length of the first value, selecting the suitable cell.

20. The method in a first node according to claim 17, comprising:
as a response to the first cell not meeting S criterion within a first time length, initiating measurements on all neighboring cells; the first time length depending on whether the first SSB group is on demand;
wherein the first node selects the first cell.
